(19) United States
(12) Patent Application Publication
(10) Pub. No.: US 2026/0133782 A1
(43) Pub. Date: May 14, 2026

(54) TRANSLATING PROGRAMS FROM A FIRST PROGRAMMING LANGUAGE TO A SECOND PROGRAMMING LANGUAGE

(71) Applicant: Schlumberger Technology Corporation, Sugar Land, TX (US)

(72) Inventor: Gary Gex, Houston, TX (US)

(21) Appl. No.: 18/942,891

(22) Filed: Nov. 11, 2024

(51) Int. Cl. G06F 8/51; G06F 8/41

(52) U.S. Cl. CPC G06F 8/51; G06F 8/42

(57) ABSTRACT

A program translation system may generate a first program source internal representation expressed using a source language representation of a source programming language and a first program target internal representation that is expressed using a target language representation of a target programming language. The system may interpret the first program source and target internal representations with first program data to generate a first program source and target results. The system may, when the source and target results are inconsistent, modify the target language representation. The system may, when the source and target results are consistent, generate a second program source internal representation of a second program. The system may use the second program source internal representation to generate a second program target internal representation of the second program. The system may use the second program target internal representation to generate a second program in the target programming language.

### BACKGROUND OF THE DISCLOSURE

Computer programs are expressed in programming languages to instruct a computing system to perform various tasks. A computer program may be written in a first programming language. In some situations, a user may desire for the computer program to be written in a second programming language.

### SUMMARY

In some aspects, the techniques described herein relate to a method for translation between source and target programming languages. A translation model, based on a first program in a first programming language, generates a first program source internal representation that is expressed using a source language representation of a source programming language. Based on the first program, the translation model generates a first program target internal representation that is expressed using a target language representation of a target programming language. The translation model interprets the first program source internal representation with first program data to generate a first program source result. The translation model interprets the first program target internal representation with the first program data to generate a first program target result. The translation model compares the first program source result and the first program target result for consistency. When the first program source result and the first program target result are inconsistent, the translation model modifies at least one of the source language representation or the target language representation. When the first program source result and the first program target result are consistent, and based on a second program source program in the source programming language and the source language representation, the translation model generates a second program source internal representation of the second program source program. Using the second program source internal representation, and based on the target language representation, the translation model generates a second program target internal representation of the second program source program. Using the second program target internal representation, the translation model generates a second program target program in the target programming language.

In some aspects, the techniques described herein relate to a method for translation between source and target programming languages. A translation model, based on a first program in a first programming language, generates a first internal representation of the first program. Based on the first internal representation, the translation model generates a second internal representation of the first program. Based on the second internal representation, the translation model generates a second program expressed in a second programming language.

In some aspects, the techniques described herein relate to a method for training a generative artificial intelligence (AI) model to translate between source and target programming languages. A program translation system trains the generative AI model on a source language corpus of a source programming language and a target language corpus of a target programming language. The program translation system generates a first program source internal representation of a first program. The program translation system generates a first program target internal representation of the first program. Using program data, the program translation system applies an execution model to the first program source internal representation. The execution model outputs source internal results. Using program data, the program translation system applies the execution model to the first program target internal representation. The execution model outputs target internal results. The program translation system compares the source internal results and the target internal results for consistency between the source internal results and the target internal results. When the source internal results and the target internal results are inconsistent, the program translation system modifies the first program target internal representation.

This summary is provided to introduce a selection of concepts that are further described in the detailed description. This summary is not intended to identify key or essential features of the claimed subject matter, nor is it intended to be used as an aid in limiting the scope of the claimed subject matter. Additional features and aspects of embodiments of the disclosure will be set forth herein, and in part will be obvious from the description, or may be learned by the practice of such embodiments.

### BRIEF DESCRIPTION OF THE DRAWINGS

In order to describe the manner in which the above-recited and other features of the disclosure can be obtained, a more particular description will be rendered by reference to specific embodiments thereof which are illustrated in the appended drawings. For better understanding, the like elements have been designated by like reference numbers throughout the various accompanying figures. While some of the drawings may be schematic or exaggerated representations of concepts, at least some of the drawings may be drawn to scale. Understanding that the drawings depict some example embodiments, the embodiments will be described and explained with additional specificity and detail through the use of the accompanying drawings in which:

FIG. 1A is a representation of a program translation system, according to at least one embodiment of the present disclosure.

FIG. 1B is a representation of a computing system.

FIG. 2 is a schematic representation of a program translation system, according to at least one embodiment of the present disclosure.

FIG. 3 is a flowchart of a method for training a generative AI model to translate a program from a source programming language to a target programming language.

FIG. 4 is a flowchart of a method for training a generative AI model to translate a program from a source programming language to a target programming language.

FIG. 5 is a flowchart of a method for translating a program from a source programming language to a target programming language.

FIG. 6A is a flowchart of a method for translating a program from a source programming language to a target programming language.

FIG. 6B is a flowchart of a method for translating a program from a source programming language to a target programming language.

FIG. 7 is a flowchart of a method for translating a program from a source programming language to a target programming language.

FIG. 8 is a flowchart of a method for translating a program from a source programming language to a target programming language.

FIG. 9 is a flowchart of a method for training a generative AI model to translate a program from a source programming language to a target programming language.

FIG. 10 is a schematic representation of a computing system, according to at least one embodiment of the present disclosure.

### DETAILED DESCRIPTION

This disclosure generally relates to devices, systems, and methods for translating a computer program from a first programming language to a second programming language. In some situations, a user may have a computing program that is written in a first programming language (also referred to herein as a source programming language). The user may desire to implement the computing program in a second programming language (also referred to as a target programming language). For example, the second programming language may be more accessible to a user, the user may not have knowledge of (or may have limited knowledge of) the first programming language, the user's computing device may not compile, assemble, or otherwise interpret the first programming device, the user may not have access to (e.g., via licenses) the first programming language or interpreters thereof, there may be a need to update a program in a first programming language to a second, newer programming language, and so forth. Converting or translating the computing program from the first programming language to the second programming language may require extensive knowledge of both the first programming language and the second programming language. Further, converting or translating the computing program from the first programming language to the second programming language may be time-intensive, involving multiple rounds of manual testing to validate the translation.

In accordance with at least one embodiment of the present disclosure, a translation model may be trained to translate a computing program from the first programming language to the second programming language. The translation model may be trained on a corpus of the first and second programming languages. This may result in the translation model generating a language representation of the first and second programming languages, respectively. The language representation may be an unambiguous representation of the programming languages. As a non-limiting example, the language representation may include a deterministic context-free grammar (DCFG). In some embodiments, the translation model may generate the language representation. In some embodiments, the corpus of the first or second programming language may include the language representation.

The translation model may generate an internal representation of a training program in both the first and second programming languages, expressed in the first and second language representations, respectively. As discussed in further detail herein, the training program may include a known program that has well understood inputs and outputs. The internal representations may then be compared, and the training program may determine how to convert the internal representation in the first language to the internal representation in the second language.

The translation model may receive a second program. The second program may be written in the first programming language, and the user may desire to translate the second program to the second programming language. The translation model may generate an internal representation of the second program, expressed in the first language representation. The translation model may then convert the internal representation from the first language representation to an internal representation in the second language representation. The translation model may then convert the internal representation in the second language representation to the second program in the second programming language. In this manner, the translation model may automatically and accurately translate computing programs from the first programming language to the second programming language.

The translation model may check for consistency between the language representations. For example, during training of the translation model, the internal representations of the first program may be interpreted using first program data that has known outputs in the first program. The results of the internal representations may be compared for consistency. When the results are inconsistent, the language representation of the second programming language may be modified or adjusted. This process may be repeated until the results are consistent.

As illustrated by the foregoing discussion, the present disclosure utilizes a variety of terms to describe features and advantages of the language translation system. Additional detail is now provided regarding the meaning of such terms. As an example, the term “generative artificial intelligence model” (or “generative AI model”) refers to a computational system that utilizes deep learning and a large number of parameters (e.g., billions or trillions for a large version and fewer for a small version) and trained on one or more extensive datasets to produce coherent, contextually relevant, and fluent outputs (e.g., text and/or images) specific to a particular topic. In many cases, a generative AI model is an advanced computational system that uses natural language processing, machine learning, and/or image processing to generate human-like responses that are coherent and contextually relevant. For instance, generative AI models can create outputs in various formats, including one-word answers, long narratives, images, videos, labeled datasets, documents, tables, and presentations.

Moreover, generative AI models are primarily based on transformer architectures for understanding, generating, and manipulating human language. Generative AI models can also utilize other types of architectures such as recurrent neural network (RNN) architecture, long short-term memory (LSTM) model architecture, convolutional neural network (CNN) architecture, or other types of architectures. Examples of generative AI models include generative pre-trained transformer (GPT) models like GPT-3.5, GPT-4, and GPT-4o, bidirectional encoder representations from transformers (BERT) models, text-to-text transfer transformer models like T5, conditional transformer language (CTRL) models, and Turing-NLG. Other types of generative AI models include sequence-to-sequence models (Seq2Seq), vanilla RNNs, and LSTM networks. In some instances, a generative AI model includes a large language model (LLM), a small language model (SLM), a large action model (LAM), and a small action model (SAM), which serve as text-based versions of a generative AI model, such as those that receive text prompts and/or generate text outputs. In various implementations, a generative AI model is a multimodal generative model that receives multiple input formats (e.g., text, images, video, data structures) and/or generates multiple output formats.

As used herein, a “programming language” is a system of notation for human interaction with a computing device or computing system. A programming language may include one or more abstractions from a machine code to notations more easily interpreted by human operators. Machine code is difficult for humans to understand, and programming languages provide a user-friendly mechanism to provide instructions to the computing device, which may then be assembled or otherwise interpreted by the computing device. The level of abstraction may result in programming languages ranging from “low-level,” or with a small amount of abstraction, to “high-level,” or with a relatively high amount of abstraction, which may improve the accessibility of the programming language for humans.

Different programming languages are developed for different purposes, including ease of programming, to facilitate different tasks, to analyze, store, and process databases, and so forth. Programming languages include various elements, such as syntax, semantics, data types, variables, abstractions, grammar, and so forth. Different programming languages may be different in one or more of their elements. This may result in a set of instructions written or data stored in a first programming language being incompatible (e.g., non-executable) with a second programming language. Non-limiting examples of programming languages for many computing applications in general computing, robotics, industrial control, typesetting, Artificial Intelligence/Machine Learning (AI) related processing, Graphics Processing Unit (GPU) based processing, etc., include, but are not limited to Python, Java, JavaScript, TypeScript, LeX, LaTex, C, C+, C++, C#, PHP, Ruby, Swift, Go, R, TypeScript, Kotlin, Rust, SQL, Fortran, MATLAB, Visual Basic, Perl, Julia, Ada, Lisp, Hardware Description Languages (HDLs), D, Pascal, the binary language of moisture vaporators, and so forth. In some embodiments, programming languages that are fully, or partially, graphics based, such as the non-limiting examples of Ladder Logic, Function Block Diagrams, and Sequential Function Chart. In some applications, the foregoing graphics-based languages may be used in the context of control systems using Programable Language Controllers (PLCs), while other PLCs'programming language variants may be text-based, such as Structured Text and Instruction List or other languages for PLC control in accordance with IEC 61131-3 and other relevant standards. While specific programming languages may be discussed herein, the techniques presented herein may be applied to any programming language, including programming languages yet to be developed.

As used herein, a “computer program” or a “program” is a series of instructions that cause a computing system to perform an action. A computing program may be written or expressed in a programming language, with the ordered combination of notation in the programming language causing the computing system to implement the instructions. The actions may be any action that the computing system may implement, including simple arithmetic, complex mathematics, data analysis, data storage, image processing, and so forth.

A “language representation” may be a representation of a programming language that may be used to express instructions from a programming language accurately and independent of the programming language. The language representations may remove or adjust the abstractions in a programming language to increase accuracy, remove ambiguities, or otherwise alter the accuracy of the representation of the language. In some embodiments, the language representations are specific to computing systems. Non-limiting examples of language representations include context-free grammars, deterministic context-free grammars, context-free languages, regular grammars, attribute grammars, context-sensitive grammars, parsing expression grammars, tree adjoining grammars, extended Backus-Naur Form representations, hardware-specific intermediate code or representations for specific PLCs (which may include textual representations of the graphical elements in some PLCs languages), and other language representations. An “internal representation” may be a computer program that is expressed in a particular language representation. The internal representation of a computer program may be configured or designed to perform the same functionality as the computer program in the programming language, while using the expression or notation of the language representation. As discussed further herein, the internal representation may be internal to a translation model, or to a model trained in translation between first and second programming languages.

As used herein, a “training program,” a “known program,” or a “testing program” may be a computer program that has known outputs or results when combined with particular test data. The training program may include any computer program. For example, the training program may include an algorithm expressed or described in well-known numerical recipes or other sources of complex algorithms useful in the specific computing field of interest. In some examples, the training program may include known data analysis algorithms, data storage algorithms, image processing algorithms, including medical imaging, financial analysis, commodities analysis and processing, logistics analysis and processing, industrial and robotic control, or database management routines, and other algorithms that consistently produce known, repeatable results in response to test data or other known inputs.

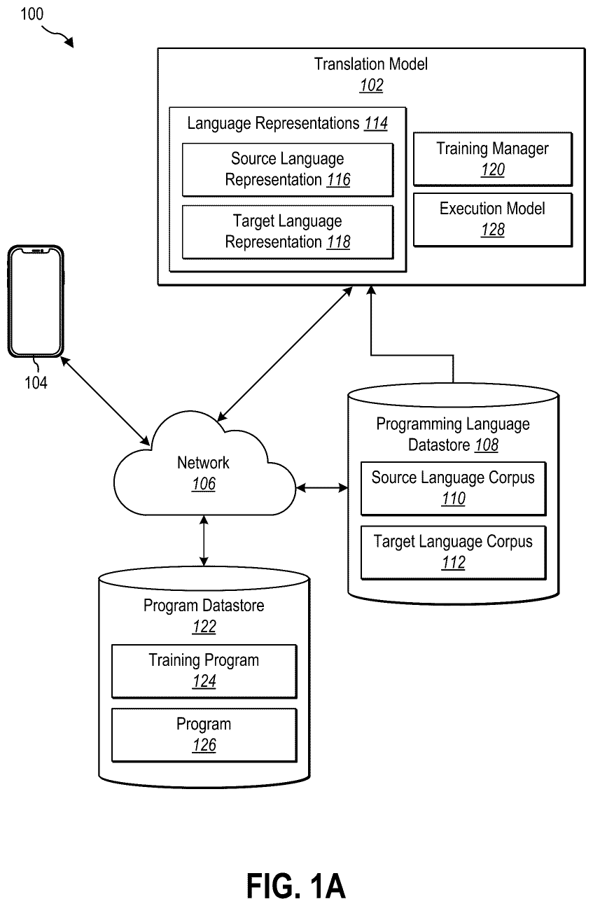

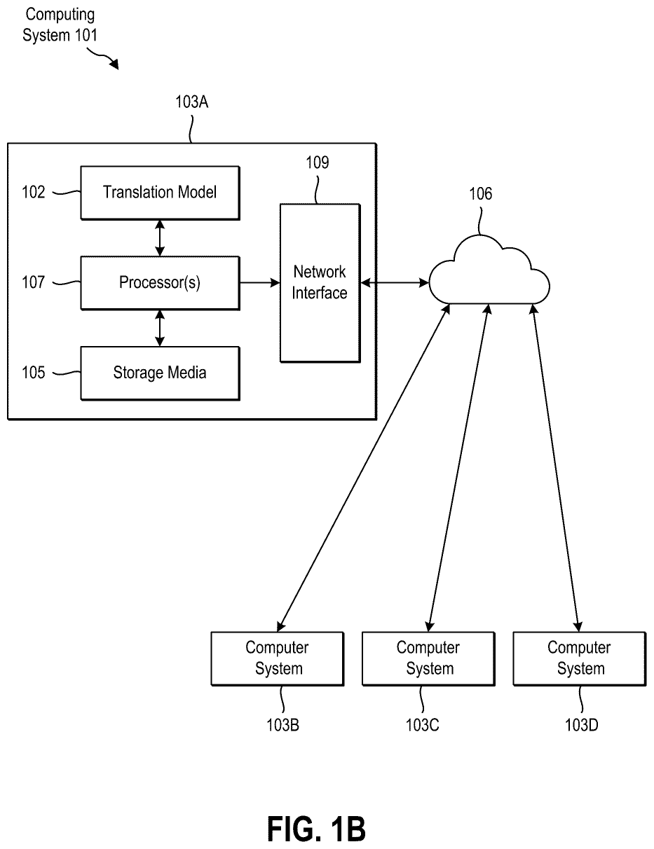

FIG. 1A is a representation of a program translation system 100, according to at least one embodiment of the present disclosure. The program translation system 100 includes a translation model 102 that may be trained to convert a computing program from a source programming language (e.g., the programming language in which the program was originally written) to a target programming language (e.g., the programming language in which a user desires the program to be written). The translation model 102 may be any type of model. For example, the translation model 102 may include a generative AI model. In some examples, the translation model 102 may include an LLM or other language model.

A user may interact with the translation model 102 via a user device 104. For example, a user may enter commands into the user device 104 and receive output from the user device 104. The translation model 102 may be in communication with the user device 104 over a network 106, such as the Internet. For example, the translation model 102 may be implemented on a server device in a cloud computing network. The user device 104 may access the cloud computing network over the network 106. In some embodiments, the translation model 102 may be implemented on a single server device on the cloud computing network. In some embodiments, one or more elements of the translation model 102 may be distributed over multiple server devices, including over multiple racks, facilities, or nodes, on the cloud computing network.

FIG. 1B depicts an example computing system 101 in accordance with some embodiments. The computing system 101 can be an individual computer system 103A or an arrangement of distributed computer systems. In some embodiments, the computing system 101 may be implemented online and distributed via Software-as-a-Service (Saas). The computer system 103A includes one or more translation modules 102 that are configured to perform various tasks according to some embodiments, such as one or more methods disclosed herein. To perform these various tasks, translation model 102 executes independently, or in coordination with, one or more processors 107, which is (or are) connected to one or more storage media 105. The processor(s) 107 is (or are) also connected to a network interface 109 to allow the computer system 103A to communicate over a data network 106 with one or more additional computer systems and/or computing systems, such as 103B, 103C, and/or 103D (note that computer systems 103B, 103C and/or 103D may or may not share the same architecture as computer system 103A, and may be located in different physical locations, e.g., computer systems 103A and 103B may be on a ship underway on the ocean, while in communication with one or more computer systems such as 103C and/or 103D that are located in one or more data centers on shore, other ships, and/or located in varying countries on different continents). Note that data network 106 may be a private network, it may use portions of public networks, it may include remote storage and/or applications processing capabilities (e.g., cloud computing).

A processor can include a microprocessor, microcontroller, processor module or subsystem, programmable integrated circuit, programmable gate array, or another control or computing device.

The storage media 105 can be implemented as one or more computer-readable or machine-readable storage media. Note that while in the example embodiment of FIG. 1B storage media 105 is depicted as within computer system 103A, in some embodiments, storage media 105 may be distributed within and/or across multiple internal and/or external enclosures of computing system 103A and/or additional computing systems. Storage media 105 may include one or more different forms of memory including semiconductor memory devices such as dynamic or static random access memories (DRAMs or SRAMs), erasable and programmable read-only memories (EPROMs), electrically erasable and programmable read-only memories (EEPROMs) and flash memories; magnetic disks such as fixed, floppy and removable disks; other magnetic media including tape; optical media such as compact disks (CDs) or digital video disks (DVDs), BluRays or any other type of optical media; or other types of storage devices. Note that the instructions discussed above can be provided on one computer-readable or machine-readable storage medium, or alternatively, can be provided on multiple computer-readable or machine-readable storage media distributed in a large system having possibly plural nodes and/or non-transitory storage means. Such computer-readable or machine-readable storage medium or media is (are) considered to be part of an article (or article of manufacture). An article or article of manufacture can refer to any manufactured single component or multiple components. The storage medium or media can be located either in the machine running the machine-readable instructions, or located at a remote site from which machine-readable instructions can be downloaded over a network for execution.

It should be appreciated that computer system 103A is one example of a computing system, and that computer system 103A may have more or fewer components than shown, may combine additional components not depicted in the example embodiment of FIG. 1B, and/or computer system 103A may have a different configuration or arrangement of the components depicted in FIG. 1B. The various components shown in FIG. 1B may be implemented in hardware, software, or a combination of both, hardware and software, including one or more signal processing and/or application specific integrated circuits.

It should also be appreciated that while no user input/output peripherals are illustrated with respect to computer systems 103A, 103B, 103C, and 103D, many embodiments of computing system 101 (such as the network 106 of FIG. 1A) include computer systems with keyboards, mice, touch screens, displays, etc. Some computer systems in use in computing system 101 may be desktop workstations, laptops, tablet computers, smartphones, smart watches, internet-of-things (IoT) devices, server computers, etc.

Further, the steps in the processing methods described herein may be implemented by running one or more functional modules in information processing apparatus such as general purpose processors or application specific chips, such as ASICs, FPGAs, PLDs, or other appropriate devices. These modules, combinations of these modules, and/or their combination with general hardware are included within the scope of protection.

The translation model 102 may be trained on the source and target programming languages. For example, the translation model 102 may be in communication with a programming language datastore 108. The programming language datastore 108 may include details regarding two or more programming languages. For example, the programming language datastore 108 may include a subject-matter corpus of the programming language. The subject-matter corpus of a programming language may include programming language grammar descriptions, programming language syntax descriptions, coding guides, user manuals, textbooks, third-party materials (e.g., tutorials, blog posts, social media posts, sample programs), application guides, language representations, any other programming language descriptions, and combinations thereof.

The programming language datastore 108 may include the subject-matter corpus for any programming language, including a source language corpus 110 and a target language corpus 112, and any number of other programming language corpora, and combinations thereof. The source language corpus 110 may include details regarding the source programming language, and the target language corpus 112 may include details regarding the target programming language.

The translation model 102 may be trained on the source language corpus 110 and the target language corpus 112. Training the translation model 102 on the source language corpus 110 and the target language corpus 112 may cause the translation model 102 to learn the elements of the source programming language and the target programming language. This may facilitate the translation model 102 to analyze programs in the source and target programming languages. For example, training the translation model 102 on the source and target language corpora may enable the translation model 102 to identify the purpose, inputs, outputs, and analysis mechanisms of a particular program. In some examples, training the translation model 102 on the source and target language corpora may enable the translation model 102 to generatively create code or sections of code for a program in one or both of the source programming language and the target programming language.

In accordance with at least one embodiment of the present disclosure, training the translation model 102 on the source language corpus 110 and the target language corpus 112 may result in the translation model 102 being trained in language representations 114 of the first and second programming languages, including a source language representation 116 and a target language representation 118. The translation model 102 may learn the language representations 114 in any manner. For example, the translation model 102 may generate the source language representation 116 and/or the target language representation 118 during training. In some examples, the source language corpus 110 and/or the target language corpus 112 may include a pre-determined language representation, and training the translation model 102 may cause the translation model 102 to learn the pre-determined language representation from the respective corpora.

The translation model 102 may include a training manager 120. The training manager 120 may facilitate or manage training of the translation model 102, including fine-tuning the translation model 102. The training manager 120 may train the translation model 102 in any manner, or using any type of training technique. For example, the training manager 120 may train the translation model 102 using supervised learning, unsupervised learning, semi-supervised learning, self-supervised learning, reinforcement learning, transfer learning, multi-instance learning, inductive learning, deductive learning, transductive learning, multi-task learning, active learning, online learning, ensemble learning, any other learning or training technique, and combinations thereof.

The translation model 102 may receive a program from a program datastore 122. The program datastore 122 may include one or more training programs 124 and one or more programs to be translated 126. The training programs 124 may include programs used to train and/or fine-tune the translation model 102, and the programs to be translated 126 may include one or more programs that the user may desire to translate from the source programming language to the target programming language. The training programs 124 may be written or expressed in both the source and target programming languages. The programs to be translated 126 may be written or expressed in only the source programming language, and not written or expressed in the target programming language.

When the translation model 102 receives a program from the program datastore 122, the translation model 102 may generate an internal representation of the program based on the language representation of the programming language in which the program is written. For example, during training, the training manager 120 may direct the translation model 102 to receive one or more of the training programs 124 in both the source and target programming languages. When the translation model 102 receives the training program 124, the translation model 102 may generate an internal representation of the training program 124 expressed in both the source language representation 116 and the target language representation 118. For example, the translation model 102 may generate a source internal representation of the training program 124 expressed in the source language representation 116 and a target internal representation of the training program 124 expressed in the target language representation 118.

After generating the source internal representation and the target internal representation, the translation model 102 may use test data as inputs with the source and target internal representations. For example, an execution model 128 may implement, interpret, compile, or otherwise use the test data as inputs with the source and target internal representations. This may generate source and target results for the training program. The training manager 120 may compare the source and target results for consistency (e.g., perform a consistency check). For example, when the source and target results are the same and consistent with the known results from the test data, then the language representations 114 may be representative of their respective languages. The training manager 120 may compare the source and target results for consistency in any manner. For example, the training manager 120 may apply a regression test to check the source and target results for consistency.

When the source and target results are not the same, then the translation model 102 may modify at least one of the language representations 114. For example, the translation model 102 may modify the target language representation 118 to more accurately represent the target programming language. In some examples, the translation model 102 may modify the source language representation 116 to more accurately represent the source programming language. In some embodiments, the translation model 102 may modify the language representations 114 based on the known results of the test data. For example, when the source and/or target results are inconsistent with the known results for the test data, the translation model 102 may modify the source language representation 116 and/or the target language representation 118.

The translation model 102 may then generate a new internal representation based on the modified language representations 114 and generate new source and target results. The training manager 120 may compare the new source and target results for consistency, and modify the language representations 114 if the new source and target results are inconsistent. This process may be repeated until the source and target results are consistent with each other and the known results. In some embodiments, the training manager 120 may manage training of the translation model 102 based on multiple training programs 124 to fine-tune and generate more robust language representations 114 of the source and target languages.

In some embodiments, when the translation model 102 is trained (e.g., when the results from the training programs 124 are internally consistent), the translation model 102 may identify correlations between the source language representation 116 and the target language representation 118. For example, based on the internal representations of the training programs 124 and the language representations 114, the translation model 102 may identify mechanisms to translate a program from the source internal representation expressed in the source language representation 116 to the target internal representation expressed in the target language representation 118. This may facilitate translation from the source programming language to the target programming language.

In accordance with at least one embodiment of the present disclosure, to translate a program 126 from the source programming language to the target programming language, the translation model 102 may generate a source internal representation of the program 126 expressed in the source language representation 116. The translation model 102 may then convert the source internal representation of the program 126 to a target internal representation of the program 126. The program 126 may then, using the target internal representation of the program 126, generate the program 126 in the target programming language.

The translation model 102 may check the consistency and/or accuracy of the translation. For example, the translation model 102 may use test data as inputs with the program 126 in both the source programming language and the target programming language, generating source and target results of the program 126. The translation model 102 may compare the source and target results of the program 126 for consistency. When the source and target results are consistent, the program 126 may be considered translated, and the translation model 102 may provide the translated program 126 to the user via the user device 104. When the source and target results are inconsistent, the translation model 102 may modify the internal representation of the program 126 in the target language representation 118 and/or modify the target language representation 118 to improve the accuracy of the translation.

In some embodiments, the translation model 102 may be verified and further trained or fine-tuned by translating one or more of the training programs 124. For example, the translation model 102 may receive one of the training programs 124 in the source programming language. The translation model 102 may generate the internal representation of the selected training program 124 expressed in the source language representation 116. The translation model 102 may then convert the internal representation of the selected training program 124 expressed in the source language representation 116 to an internal representation expressed in the target language representation 118. The translation model 102 may then generate the training program 124 in the target programming language. The translation model 102 may use test data as inputs with the original training program in the source language and the translated training program in the target language and compare the resulting target and source results for consistency, and modify the target language representation 118 based on the comparison. In some embodiments, the training manager 120 may compare the lines of code of the training program 124 written in the target programming language to the translated training program 124 translated to the target programming language. The training manager 120 may modify the model used to convert the internal representations and/or generate the translated program. This may facilitate the generation of more representative and/or accurate programs by the translation model 102.

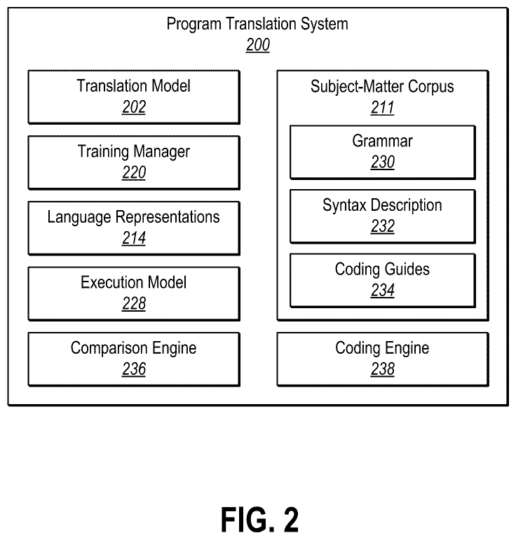

FIG. 2 is a schematic representation of a program translation system 200, according to at least one embodiment of the present disclosure. Each of the components of the program translation system 200 can include software, hardware, or both. For example, the components can include one or more instructions stored on a computer-readable storage medium and executable by processors of one or more computing devices, such as a client device or server device. When executed by the one or more processors, the computer-executable instructions of the program translation system 200 can cause the computing device(s) to perform the methods described herein. Alternatively, the components can include hardware, such as a special-purpose processing device to perform a certain function or group of functions. Alternatively, the components of the program translation system 200 can include a combination of computer-executable instructions and hardware.

Furthermore, the components of the program translation system 200 may, for example, be implemented as one or more operating systems, as one or more stand-alone applications, as one or more modules of an application, as one or more plug-ins, as one or more library functions or functions that may be called by other applications, and/or as a cloud-computing model. Thus, the components may be implemented as a stand-alone application, such as a desktop or mobile application. Furthermore, the components may be implemented as one or more web-based or cloud-based applications hosted on a remote server available as a SaaS application accessible to users. One or more of the components may also be implemented in a suite of mobile device applications or “apps.”

The program translation system 200 may include a translation model 202. As discussed above with respect to FIG. 1A, the translation model 202 may include a generative AI model that is trained on a subject-matter corpus 211, including the corpus of one or more programming languages. The subject-matter corpus 211 may include programming language specific information, such as grammar 230, syntax descriptions 232, coding guides 234, and so forth.

A training manager 220 may manage or facilitate training of the translation model 202 based on the subject-matter corpus 211. Training of the translation model 202 may result in the translation model 202 maintaining one or more language representations 214 of the languages in the subject-matter corpus 211. When the translation model 202 receives a program, the translation model 202 may generate an internal representation of the program using the associated language representation 214. For example, when the translation model 202 receives a program in a source programming language, the translation model 202 may generate an internal representation of the program using a language representation 214 of the source programming language. In some examples, during training, the translation model 202 may generate an internal representation of a training program using multiple language representations 214, based on the languages in which the training program is written.

The translation model 202 may validate or check using an execution model 228. For example, the execution model 228 may use test data as inputs with the internal representations of the training programs to generate results. A comparison engine 236 may compare the results generated by the execution model 228. When the results are inconsistent, the training manager 220 may adjust the one or more language representations 214. As discussed herein, this process may be repeated until the results are internally consistent (e.g., the internal representations are consistent) and/or consistent with results from the original programs from which the internal representations were generated.

To translate a program, the translation model 202 may receive the program in the source language. The translation model 202 may generate a source internal representation of the program in a source language representation of the source language. A coding engine 238 may convert the source internal representation of the program to a target internal representation of the program in a target internal representation of the target language. The coding engine 238 may then generate code for the program in the target programming language using the target internal representation.

In some embodiments, the training manager 220 may train the coding engine 238. For example, the training manager 220 may cause the translation model 202 to translate training programs from the source to the target language. The execution model 228 may use test data as inputs with the training program in the source programming language, the target programming language, and the translated program in the target programming language. When the results of the test data are inconsistent, the training manager 220 may modify the coding engine 238. This may adjust the resulting translated program in the target language. The training manager 220 may repeat this process until the program in the source language and the translated program in the target language provide consistent results.

In some embodiments, the training manager 220 may train the translation model 202 on general information. For example, the training manager 220 may train the translation model 202 on general computer science knowledge. In some examples, the translation model 202 may be a pre-trained language model, trained on a general massive language database. In some examples, the training manager 220 may train the translation model 202 on general information, such as a general knowledge encyclopedia. In some examples, the training manager 220 may train the translation model 202 on industry information. For example, in the oil and gas exploration and drilling context, the training manager 220 may train the translation model 202 on dictionaries or encyclopedias of geology, geophysics, petrophysics, geochemistry, drilling technology, production technology, pipe, valve, and flow assurance technology, physics, and chemistry. In some embodiments, the training manager 220 may train the translation model 202 in other industry-specific knowledge, such as the mining industry, the manufacturing industry, the transportation industry, the medical industry, the communication industry, the gaming industry, any other industry, and combinations thereof. Training the translation model 202 on general and specific knowledge may help to provide context for the translation of programs, including programs that are specific to a particular industry.

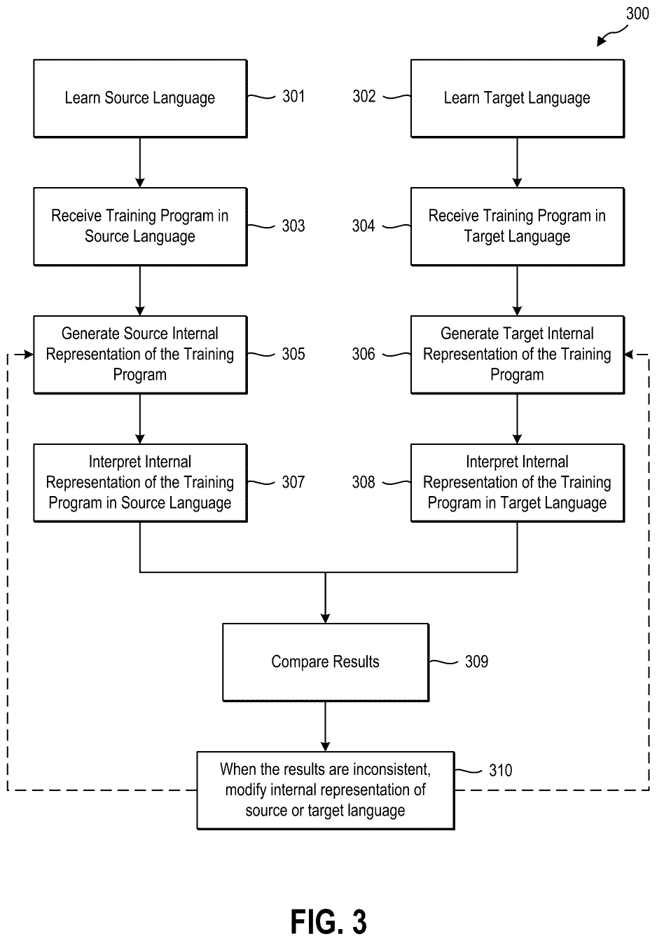

FIG. 3-10, the corresponding text, and the examples provide a number of different methods, systems, devices, and computer-readable media of the program translation system. In addition to the foregoing, one or more embodiments can also be described in terms of flowcharts comprising acts for accomplishing a particular result, as shown in FIG. 3-10. FIG. 3-10 may be performed with more or fewer acts. Further, the acts may be performed in differing orders. Additionally, the acts described herein may be repeated or performed in parallel with one another or parallel with different instances of the same or similar acts.

As mentioned, FIG. 3 illustrates a flowchart of a series of acts or a method 300 for translating a program between source and target programming languages, according to at least one embodiment of the present disclosure. While FIG. 3 illustrates acts according to one embodiment, alternative embodiments may omit, add to, reorder, and/or modify any of the acts shown in FIG. 3. The acts of FIG. 3 can be performed as part of a method. The acts of FIG. 3 can be performed as part of specific-purpose computer program program(s) and/or program product(s), such as a SaaS platform. Alternatively, a computer-readable medium can comprise instructions that, when executed by one or more processors, cause a computing device to perform the acts of FIG. 3. In some embodiments, a computing system (such as the computing system 101 illustrated in FIG. 1B) can perform the acts of FIG. 3.

A program translation system may train a translation model to translate a program from a source programming language to a target programming language. The translation model may learn the source programming language at 301 and learn the target programming language at 302. As discussed in further detail herein, the translation model may be trained on corpora of the source and target programming languages.

A training program may be written in both the source programming language and the target programming language. The translation model may receive the training program written in the source programming language at 303 and receive the training program written in the target programming language at 304. The translation model may, using the training program, generate a source internal representation of the training program using the training program that is written in the source language at 305. The translation model may further generate a target internal representation of the training program using the training program that is written in the target language at 306. The source internal representation may be expressed in a source language representation of the source programming language, and the target internal representation may be expressed in a target language representation of the target programming language.

The translation model may interpret the source internal representation to generate source results at 307. The translation model may further interpret the target internal representation to generate target results at 308. For example, the translation model may include an execution model that may interpret, compile, or otherwise use test data as inputs with the source and target internal representations. Interpreting the source and target internal representations may include applying test data to the source and target internal representations. The test data may generate known results. For example, the training program may include associated test data that, when input to the training program, consistently generates known results.

The translation model may compare the source results and the target results to each other and/or to the known results at 309. For example, the translation model may compare the source results and the target results to each other and/or the known results for consistency.

In some embodiments, particularly those dealing with predictable arts, comparing the source and target results for consistency includes checking whether the specific results in the output set are the same, which makes sense if the output from the original source program is unique, e.g., a set of outputs from the source program include discrete values such as 134.82, or a specific text string that provides a uniquely determinable answer such as “Bubba Bourdain was the first applicant for the 22nd alligator-catcher job posting in the October 2024 Open Requisitions List.” Predictable arts, in this sense, can include, but are not limited to, where reliable comparisons can be based on one or more of standardizable methods, flows, and/or algorithm that create reproducible results, are based on clear metrics, and/or known data integrity measures can be applied.

In some embodiments, comparing the source results and the target results for consistency may include generating a consistency score; this approach can be beneficial for less predictable arts that deal with complex, dynamic and/or highly variable data so that results consistency determinations may be best done with ranges instead of exact values, including, e.g., forecasting models for complex systems like weather, climate, and epidemiological models, market analysis tools, AI and machine learning models, simulation ensembles, and Monte Carlo simulations, wherein varying results can be generated in different test runs given the same data inputs. Some considerations for comparing results via consistency scoring can include: using probabilistic outputs and/or output ranges; statistical metrics to understand output ranges; scenario and/or ensembles of scenario analysis; and sensitivity analysis. The consistency scoring may be a representation of how close the source results and the target results (or groups of source and target results) are to each other and/or to the known results. In some embodiments, the consistency score may be generated based on regression testing. The regression test or regression analysis may include performing one or more functional and/or non-functional tests of the programs. In some examples, the results from the training program may be numerical, and the consistency score may be a representation of how far from the numerical known results the source and target results are. The numerical consistency score may be represented as a percentage (e.g., (first results minus second results) divided by first results). In some embodiments, the results from the training program may be image-based, and the consistency score may be a representation of the number of pixels in the image that are different, or a representation of the total difference in pixel values of the image. In some embodiments, the consistency score may be a compilation of multiple comparisons based on the test data and the output results.

For example, the translation model may compare the results and determine whether the results are consistent based on the consistency score. For example, when the consistency score indicates that the results are identical (e.g., a consistency score of 100% for numerical results), the translation model may determine that there are no modifications to the source or target language representations (e.g., that the training model is fully trained). In some examples, when the consistency score indicates that the results are not the same (e.g., a consistency score of less than 100%), the translation model may determine that one or both of the source or target language representations are to be modified to improve the consistency score. The translation model may then modify one or both of the source or target language representations. Modifying the language representations may include changing one or more of the grammar elements, syntax, or other elements of the language representation.

In some embodiments, when the consistency score is within a consistency threshold, the translation model may determine that there are no modifications to the source or target language representations (e.g., that the training model is fully trained). When the consistency score is below the consistency threshold, the translation model may determine that the source or target language representations are to be modified to improve the consistency score. In some embodiments, the consistency score may be in a range having an upper value, a lower value, or upper and lower values including any of 80%, 85%, 90%, 95%, 97.5%, 99%, 99.5%, 99.9%, 99.99%, or any value therebetween. For example, the consistency score may be greater than 80%. In another example, the consistency score may be less than 99.99%. In yet other examples, the consistency score may be any value in a range between 80% and 99.99%. In some embodiments, it may be critical that the consistency score is greater than 99% to ensure consistent results in the translated programs within a margin of error of the measurements and/or program tolerances.

As discussed herein, when the results are inconsistent, the translation model may modify one or both of the source or target internal representation at 310. The translation model may then interpret the new source and/or target internal representations, compare the new results, and generate a new consistency score. This process may be repeated until the source and target results are consistent (e.g., until the consistency score is above the consistency threshold).

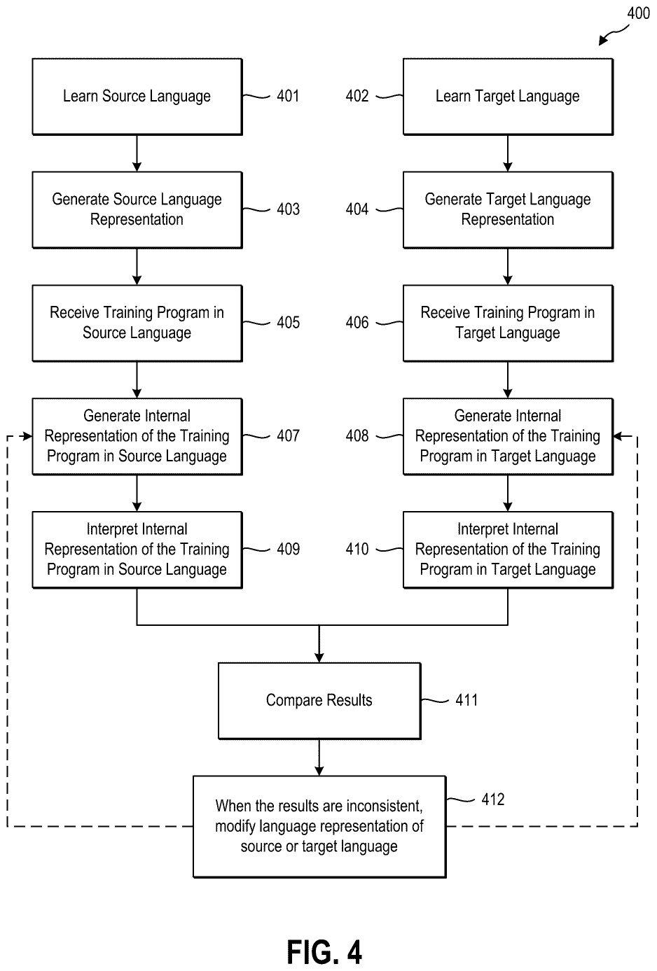

As mentioned, FIG. 4 illustrates a flowchart of a series of acts or a method 400 for translating a program between source and target programming languages, according to at least one embodiment of the present disclosure. While FIG. 4 illustrates acts according to one embodiment, alternative embodiments may omit, add to, reorder, and/or modify any of the acts shown in FIG. 4. The acts of FIG. 4 can be performed as part of a method. The acts of FIG. 4 can be performed as part of specific-purpose computer program program(s) and/or program product(s), such as a SaaS platform. Alternatively, a computer-readable medium can comprise instructions that, when executed by one or more processors, cause a computing device to perform the acts of FIG. 4. In some embodiments, a computing system (such as the computing system 101 illustrated in FIG. 1B) can perform the acts of FIG. 4.

A program translation system may train a translation model to translate a program from a source programming language to a target programming language. The translation model may learn the source programming language at 401 and learn the target programming language at 402. As discussed in further detail herein, the translation model may be trained on corpora of the source and target programming languages.

In accordance with at least one embodiment of the present disclosure, during training of the translation model, the translation model may generate language representations of the source and target programming languages. For example, the translation model may generate a source language representation of the source programming language at 403. The translation model may generate a target language representation of the target programming language at 404. For example, the translation model may generate context-free grammars for the source and target programming languages, respectively, based on the corpora of the source and target programming languages. In some examples, the corpora of the source and target programming languages may include a language representation or portions of a language representation, and generating the source and target language representations may include modifying the language representations included in the respective language corpus.

A training program may be written in both the source programming language and the target programming language. The translation model may receive the training program written in the source programming language at 405 and receive the training program written in the target programming language at 406. The translation model may, using the training program, generate a source internal representation of the training program using the training program that is written in the source language at 407. The translation model may further generate a target internal representation of the training program using the training program that is written in the target language at 408. The source and target internal representations may be expressed in the source and target language representations generated during training of the translation model.

The translation model may interpret the source internal representation to generate source results at 408. The translation model may further interpret the target internal representation to generate target results at 409. For example, the translation model may include an execution model that may interpret, compile, or otherwise use test data as inputs with the source and target internal representations. Interpreting the source and target internal representations may include applying test data to the source and target internal representations. The test data may generate known results. For example, the training program may include associated test data that, when input to the training program, consistently generates known results.

The translation model may compare the source results and the target results to each other and/or to the known results at 411. For example, the translation model may compare the source results and the target results to each other and/or the known results for consistency. Comparing the source results and the target results for consistency may include generating a consistency score, as discussed herein.

As discussed herein, when the results are inconsistent (e.g., when the consistency score is below the consistency threshold), the translation model may modify one or both of the source or target language representations at 412. The translation model may then generate a new internal representation in the modified language representation. The translation model may interpret the new target internal representation, compare the new results, and generate a new consistency score. This process may be repeated until the source and target results are consistent (e.g., until the consistency score is above the consistency threshold).

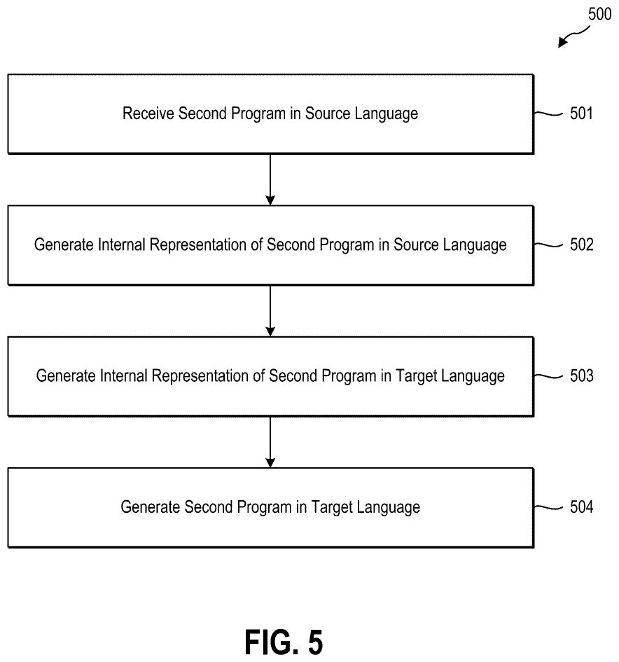

As mentioned, FIG. 5 illustrates a flowchart of a series of acts or a method 500 for translating a program between source and target programming languages, according to at least one embodiment of the present disclosure. While FIG. 5 illustrates acts according to one embodiment, alternative embodiments may omit, add to, reorder, and/or modify any of the acts shown in FIG. 5. The acts of FIG. 5 can be performed as part of a method. The acts of FIG. 5 can be performed as part of specific-purpose computer program program(s) and/or program product(s), such as a SaaS platform. Alternatively, a computer-readable medium can comprise instructions that, when executed by one or more processors, cause a computing device to perform the acts of FIG. 5. In some embodiments, a computing system (such as the computing system 101 illustrated in FIG. 1B) can perform the acts of FIG. 5.

In accordance with at least one embodiment of the present disclosure, to translate a program from a source programming language to a target programming language, a trained translation model (e.g., a translation model trained in accordance with the acts described herein) may receive a program to be translated (e.g., a second program) at 501. The second program in this method is written in the source programming language.

The translation model may generate an internal representation of the second program in the source programming language at 502. For example, the translation model may generate an internal representation of the second program in a source language representation of the source programming language. The translation model may, using the internal representation of the second program expressed in the source language representation, generate an internal representation of the second program expressed in the target language representation at 503. For example, the translation model may include a translation mechanism that may convert the internal representation expressed in the source language representation to the internal representation expressed in the target language representation.

The translation model may, using the internal representation of the second program expressed in the target language representation, generate the second program written in the target language at 504. For example, the translation model may include a translation mechanism to convert the internal representation in the target language representation to code written in the target programming language. This may result in an output of the second program written in the target programming language, completing the conversion from the first programming language to the second programming language.

The techniques described with respect to FIG. 5 may be performed independently. For example, the translation model described herein may be pre-trained and translate the second program from the source programming language to the target programming language without additional training, or only upon receiving the second program. In accordance with at least one embodiment of the present disclosure, the techniques described with respect to FIG. 5 may be performed in conjunction with the techniques described with respect to FIG. 3 and FIG. 4. For example, the translation model may be trained and then receive and translate the second program.

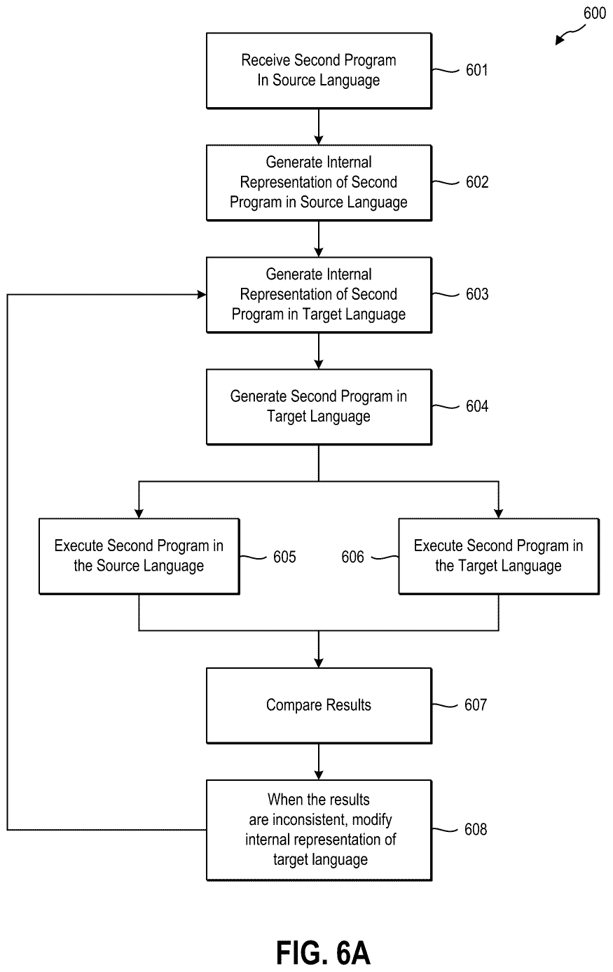

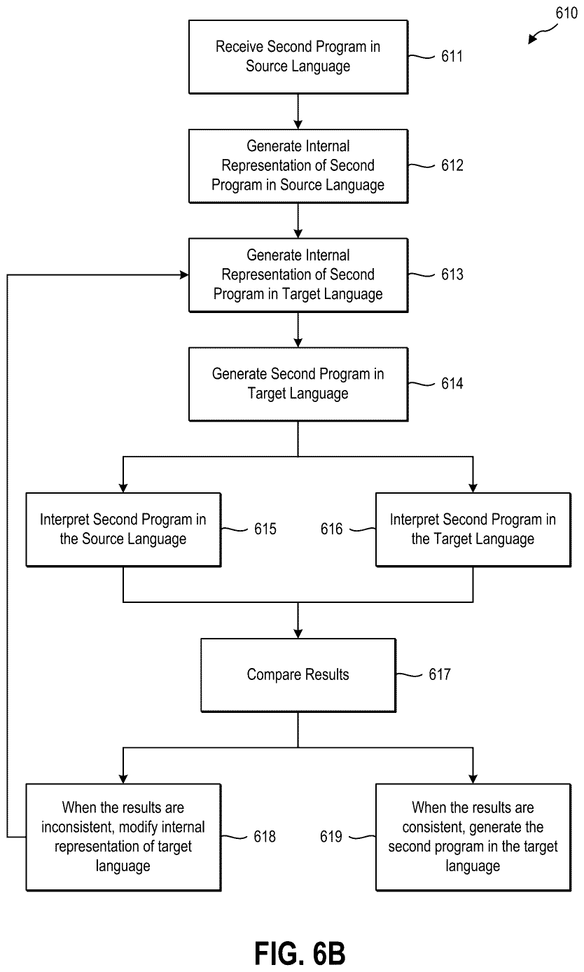

As mentioned, FIG. 6A illustrate a flowchart of a series of acts or a method 600 for translating a program between source and target programming languages, according to at least one embodiment of the present disclosure. While FIG. 6A illustrates acts according to one embodiment, alternative embodiments may omit, add to, reorder, and/or modify any of the acts shown in FIG. 6A. The acts of FIG. 6A can be performed as part of a method. The acts of FIG. 6A can be performed as part of specific-purpose computer program program(s) and/or program product(s), such as a SaaS platform. Alternatively, a computer-readable medium can comprise instructions that, when executed by one or more processors, cause a computing device to perform the acts of FIG. 6A. In some embodiments, a computing system (such as the computing system 101 of FIG. 1B) can perform the acts of FIG. 6A.

In accordance with at least one embodiment of the present disclosure, to translate a program from a source programming language to a target programming language, a trained translation model (e.g., a translation model trained in accordance with the acts described herein) may receive a program to be translated (e.g., a second program) at 601. The second program may be written in the source programming language.

The translation model may generate an internal representation of the second program in the source programming language at 602. For example, the translation model may generate an internal representation of the second program in a source language representation of the source programming language. The translation model may, using the internal representation of the second program expressed in the source language representation, generate an internal representation of the second program expressed in the target language representation at 603. The translation model may, using the internal representation of the second program expressed in the target language representation, generate the second program written in the target language at 604.

In accordance with at least one embodiment of the present disclosure, the translation model may check the second program in the target programming language for consistency. For example, the translation model may execute the second program in the source programming language at 605. The translation model may execute the second program in the target programming language at 606. Execution at 605 and 606, respectively, may be accomplished through appropriate means for those with skill in the art, including executing the second program, or compilation and then running the complied second program. Thus, the translation model may execute the second program in the source and target programming languages in any manner. For example, the translation model may use test data or other existing data associated with the second program as inputs with the second program in the source and target programming languages. This creates source and target results for the second program from executing the second program in the source and target languages, respectively, i.e., the second program in the source language outputs source results, and the second program in the target language outputs target results.

The translation model may compare the source results with the target results at 607. For example, the translation model may compare the source results and the target results to each other for consistency. Comparing the source results and the target results for consistency may include generating a consistency score, as discussed herein.

As discussed herein, when the results are inconsistent (e.g., when the consistency score is below the consistency threshold), the translation model may modify the target internal representation of the second program at 608. The translation model may then generate a new second program in the target language, interpret the new program and generate new results, compare the new results, and generate a new consistency score. This process may be repeated until the source and target results are the same, or deemed consistent (e.g., until a consistency score is above the consistency threshold).

The techniques described with respect to FIG. 6A may be performed independently. For example, the translation model described herein may be pre-trained and translate the second program from the source programming language to the target programming language without additional training, or only upon receiving the second program. In accordance with at least one embodiment of the present disclosure, the techniques described with respect to FIG. 6A may be performed in conjunction with the techniques described with respect to FIG. 3 and FIG. 4. For example, the translation model may be trained and then receive and translate the second program.

As mentioned, FIG. 6B illustrate a flowchart of a series of acts or a method 610 for translating a program between source and target programming languages, according to at least one embodiment of the present disclosure. While FIG. 6B illustrates acts according to one embodiment, alternative embodiments may omit, add to, reorder, and/or modify any of the acts shown in FIG. 6B. The acts of FIG. 6B can be performed as part of a method. The acts of FIG. 6B can be performed as part of specific-purpose computer program program(s) and/or program product(s), such as a SaaS platform. Alternatively, a computer-readable medium can comprise instructions that, when executed by one or more processors, cause a computing device to perform the acts of FIG. 6B. In some embodiments, a computing system (such as the computing system 101 of FIG. 1B) can perform the acts of FIG. 6B.

With reference to FIG. 6B, and in accordance with at least one embodiment of the present disclosure, to translate a program from a source programming language to a target programming language, a trained translation model (e.g., a translation model trained in accordance with the acts described herein) may receive a program to be translated (e.g., a second program) at 611. The second program may be written in the source programming language.

The translation model may generate an internal representation of the second program in the source programming language at 612. For example, the translation model may generate an internal representation of the second program in a source language representation of the source programming language. The translation model may, using the internal representation of the second program expressed in the source language representation, generate an internal representation of the second program expressed in the target language representation at 613. The translation model may, using the internal representation of the second program expressed in the target language representation, generate the second program written in the target language at 614.

In accordance with at least one embodiment of the present disclosure, the translation model may check the second program in the target programming language for consistency. For example, the translation model may execute the second program in the source programming language at 615. The translation model may interpret the second program in the target programming language at 616. Interpretation at 615 and 616, respectively, may be accomplished through appropriate means for those with skill in the art, including interpreting the second program line by line. Thus, the translation model may interpret the second program in the source and target programming languages in any manner. For example, the translation model may use test data or other existing data associated with the second program as inputs with the second program in the source and target programming languages. This creates source and target results for the second program from interpreting the second program in the source and target languages, respectively, i.e., the second program in the source language outputs source results, and the second program in the target language outputs target results.

The translation model may compare the source results with the target results at 617. For example, the translation model may compare the source results and the target results to each other for consistency. Comparing the source results and the target results for consistency may include generating a consistency score, as discussed herein.

As discussed herein, when the results are inconsistent (e.g., when the consistency score is below the consistency threshold), the translation model may modify the target internal representation of the second program at 618. The translation model may then generate a new second program in the target language, interpret the new program and generate new results, compare the new results, and generate a new consistency score. This process may be repeated until the source and target results are the same, or deemed consistent (e.g., until a consistency score is above the consistency threshold).

As discussed herein, when the results are consistent (e.g., when the consistency score is above the consistency threshold), the translation model may generate the second program in the target language at 619. Comparing the results at 617 and modifying the internal representation at 618 until the results are consistent may facilitate an accurate translation of the second program to the target language.

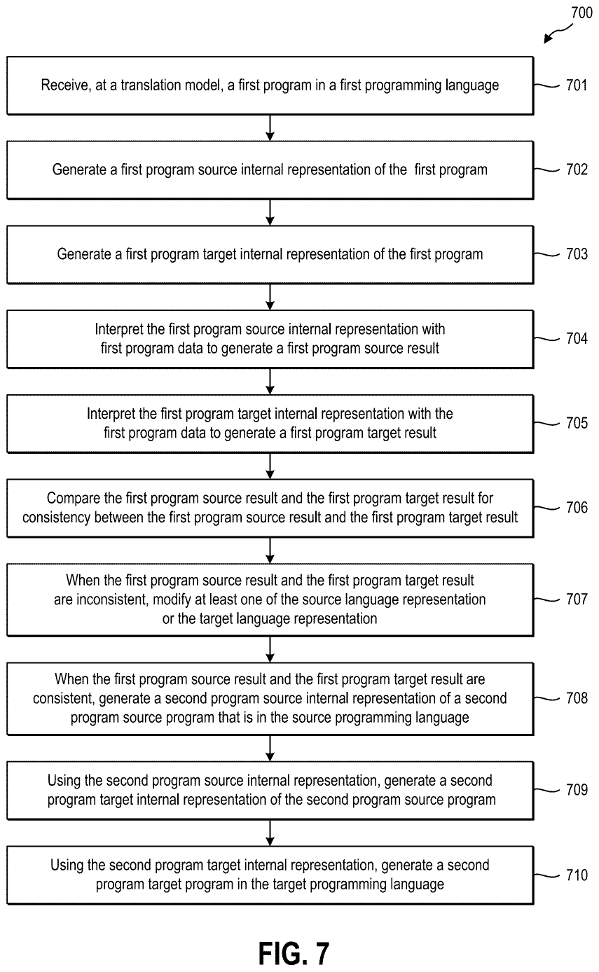

As mentioned, FIG. 7 illustrates a flowchart of a series of acts or a method 700 for translating a program between source and target programming languages, according to at least one embodiment of the present disclosure. While FIG. 7 illustrates acts according to one embodiment, alternative embodiments may omit, add to, reorder, and/or modify any of the acts shown in FIG. 7. The acts of FIG. 7 can be performed as part of a method. The acts of FIG. 7 can be performed as part of specific-purpose computer program program(s) and/or program product(s), such as a SaaS platform. Alternatively, a computer-readable medium can comprise instructions that, when executed by one or more processors, cause a computing device to perform the acts of FIG. 7. In some embodiments, a computing system (such as the computing system 101 illustrated in FIG. 1B) can perform the acts of FIG. 7.

A translation model (e.g., the translation model 102 of FIG. 1A) may receive a first program in a first programming language at 701. The translation model may generate a first program source internal representation of a first program at 702. The first program source internal representation may be expressed using a source language representation of the source programming language.

The translation model may, based on the first program, generate a first program target internal representation that is expressed using a target language representation of a target programming language at 703. For example, the first program may be written in the target programming language, and the translation model may generate the first program target internal representation based on the first program in the target programming language.

The translation model may interpret the first program source internal representation with first program data to generate a first program source result at 704. As discussed herein, the first program source result may be a numerical output, a graphical image, or other output from the first program source internal representation. The translation model may interpret the first program target internal representation with the first program data to generate a first program target result at 705. As discussed herein, the first program target result may be a numerical output, a graphical image, or other output from the first program target internal representation. The translation model may compare the first program source results and the first program target result for consistency at 706. When the first program source result and the first program target result are inconsistent, the translation model may modify at least one of the source language representation or the target language representation at 707.

When the first program source result and the first program target result are consistent, and based on a second program source program in the source program and the source language representation, the translation model may generate a second program source internal representation of the second program source program at 708. Using the second program source internal representation, and based on the target language representation, the program to be translated may generate a second program target internal representation of the second program source program at 709. Using the second program target internal representation, the translation model may generate a second program target program in the target programming language at 710.

As a specific, non-limiting example, consider an Omega® (trademark of Schlumberger Technology Corporation) seismic functional model (SFM) that is written in the Fortran programming language (e.g., the source programming language). A user may need to update an SFM from Fortran to a more modern implementation, such as Python, C#, or C++, or even Assembly code for efficiency reasons, but resources for efficient translation may not be readily available when needed. The user may desire to translate the SFM to the one of those other programming languages, such as C++ (e.g., the target programming language), thereby improving the ease of understanding, and the ability of the user to implement, modify, and understand the SFM. The user may train the translation model by providing a training program (e.g., the first program), that is known in both Fortran and C++, to the translation model. The translation model may include internal language representations of both Fortran and C++, and potentially other programming languages. The translation model may generate a Fortran internal representation of the training program (e.g., the first program source internal representation). The translation model may generate a C++ internal representation of the training program (e.g., the first program target internal representation).

The translation model may interpret the Fortran internal representation of the training program, outputting Fortran training results (e.g., the first program source results). The translation model may further interpret the C++ internal representation of the training program, outputting C++ training results (e.g., the first program target results). The translation model may compare the Fortran training results and the C++ training results for consistency.

When the Fortran training results and the C++ training results are inconsistent, the translation model may modify the Fortran and/or the C++ internal representations. When the Fortran training results and the C++ training results are consistent, the translation model may receive the SFM written in Fortran (e.g., the second program source program). The translation model may generate a Fortran internal representation of the SFM (e.g., the second program source internal representation). Using the Fortran internal representation of the SFM, the translation model may generate a C++ internal representation of the SFM (e.g., the second program target internal representation. The translation model may use the C++ internal representation of the SFM to generate the SFM written in C++ (e.g., the second program target program). In this manner, the translation model may be trained to translate and translate the SFM from Fortran to C++.

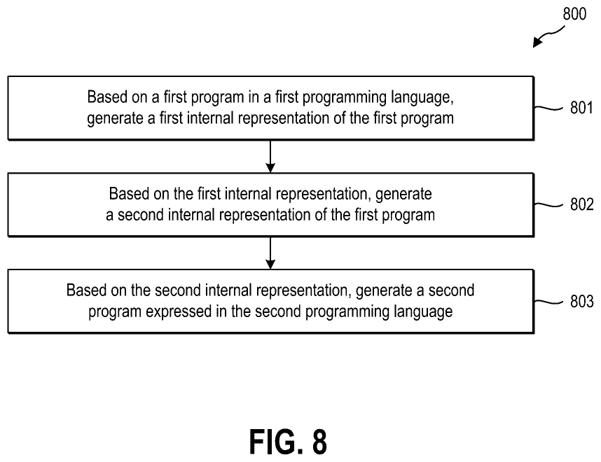

As mentioned, FIG. 8 illustrates a flowchart of a series of acts or a method 800 for translating a program between source and target programming languages, according to at least one embodiment of the present disclosure. While FIG. 8 illustrates acts according to one embodiment, alternative embodiments may omit, add to, reorder, and/or modify any of the acts shown in FIG. 8. The acts of FIG. 8 can be performed as part of a method. The acts of FIG. 8 can be performed as part of specific-purpose computer program program(s) and/or program product(s), such as a SaaS platform. Alternatively, a computer-readable medium can comprise instructions that, when executed by one or more processors, cause a computing device to perform the acts of FIG. 8. In some embodiments, a computing system (such as the computing system 101 of FIG. 1B) can perform the acts of FIG. 8.

A translation model may, based on a first program in a first programming language, generate a first internal representation of the first program at 801. The translation model may, based on the first internal representation, generate a second internal representation of the first program at 802. The translation model may, based on the second internal representation, generate a second program expressed in a second programming language at 803.

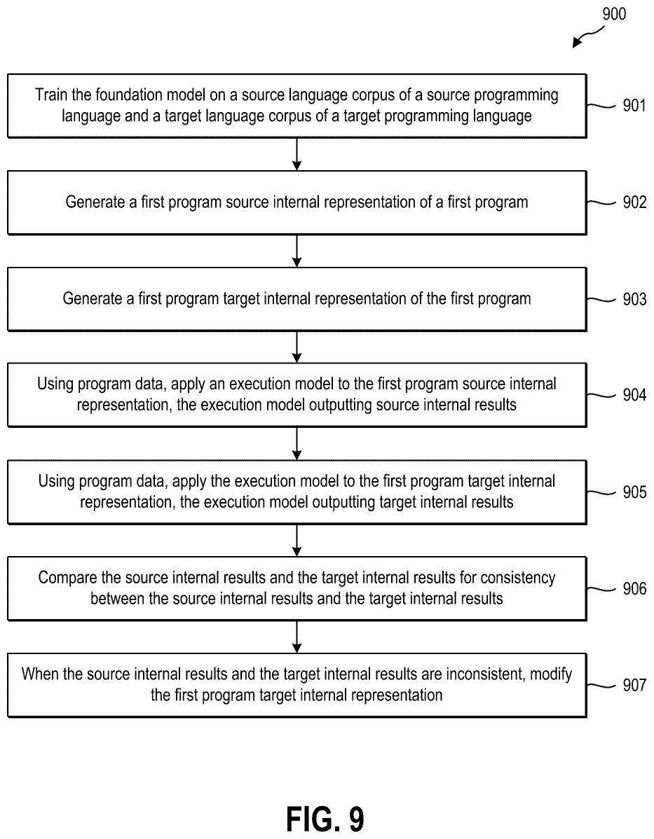

As mentioned, FIG. 9 illustrates a flowchart of a series of acts or a method 900 for training a generative AI model to translate between source and target programming languages, according to at least one embodiment of the present disclosure. While FIG. 9 illustrates acts according to one embodiment, alternative embodiments may omit, add to, reorder, and/or modify any of the acts shown in FIG. 9. The acts of FIG. 9 can be performed as part of a method. The acts of FIG. 9 can be performed as part of specific-purpose computer program program(s) and/or program product(s), such as a SaaS platform. Alternatively, a computer-readable medium can comprise instructions that, when executed by one or more processors, cause a computing device to perform the acts of FIG. 9. In some embodiments, a computing system (such as the computing system 101 of FIG. 1B) can perform the acts of FIG. 9.

A program translation system may train the generative AI model on a source language corpus of a source programming language and a target language corpus of a target programming language at 901. The program translation system may generate a first program source internal representation of a first program at 902. The program translation system may generate a first program target internal representation of the first program at 903.

The program translation system may, using the program data, apply an execution model to the first program source internal representation at 904. The execution model may output source internal results. The program translation system may, using program data, apply the execution model to the first program target internal representation at 905. The execution model may output target internal results. The program translation system may compare the source internal results and the target internal results for consistency between the source internal results and the target internal results at 906. When the source internal results and the target internal results are inconsistent, the program translation system may modify the first program target internal representation at 907.

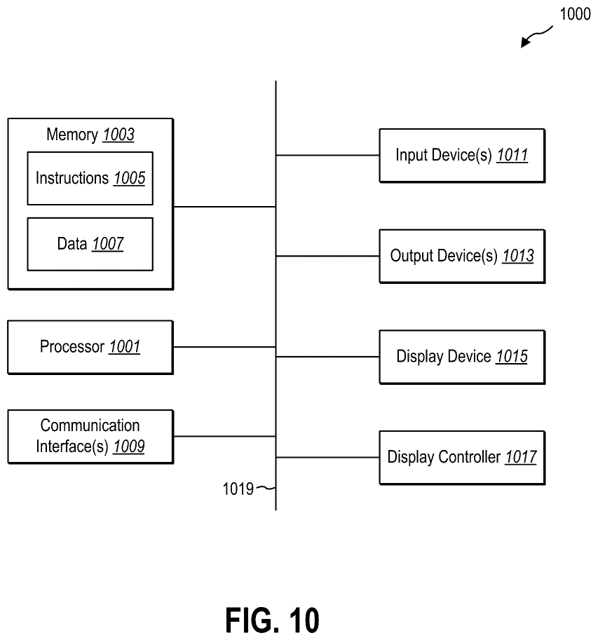

FIG. 10 illustrates certain components that may be included within a computer system 1000. One or more computer systems 1000 may be used to implement the various devices, components, and systems described herein.

The computer system 1000 includes a processor 1001. The processor 1001 may be a general-purpose single or multi-chip microprocessor (e.g., an Advanced RISC (Reduced Instruction Set Computer) Machine (ARM)), a special purpose microprocessor (e.g., a digital signal processor (DSP)), a microcontroller, a programmable gate array, etc. The processor 1001 may be referred to as a central processing unit (CPU). In some embodiments, the processor 1001 may be a graphical processing unit (GPU). Although just a single processor 1001 is shown in the computer system 1000 of FIG. 10, in an alternative configuration, a combination of processors (e.g., an ARM and DSP) could be used, and/or arrays of processors 1001.

The computer system 1000 also includes memory 1003 in electronic communication with the processor 1001. The memory 1003 may be any electronic component capable of storing electronic information. For example, the memory 1003 may be embodied as random access memory (RAM), read-only memory (ROM), magnetic disk storage media, optical storage media, flash memory devices in RAM, on-board memory included with the processor, erasable programmable read-only memory (EPROM), electrically erasable programmable read-only memory (EEPROM) memory, registers, and so forth, including combinations thereof.

Instructions 1005 and data 1007 may be stored in the memory 1003. The instructions 1005 may be executable by the processor 1001 to implement some or all of the functionality disclosed herein. Executing the instructions 1005 may involve the use of the data 1007 that is stored in the memory 1003. Any of the various examples of modules and components described herein may be implemented, partially or wholly, as instructions 1005 stored in memory 1003 and executed by the processor 1001. Any of the various examples of data described herein may be among the data 1007 that is stored in memory 1003 and used during execution of the instructions 1005 by the processor 1001.

A computer system 1000 may also include one or more communication interfaces 1009 for communicating with other electronic devices. The communication interface(s) 1009 may be based on wired communication technology, wireless communication technology, or both. Some examples of communication interfaces 1009 include a Universal Serial Bus (USB), an Ethernet adapter, a wireless adapter that operates in accordance with an Institute of Electrical and Electronics Engineers (IEEE) 802.11 wireless communication protocol, a Bluetooth® wireless communication adapter, and an infrared (IR) communication port.

A computer system 1000 may also include one or more input devices 1011 and one or more output devices 1013. Some examples of input devices 1011 include a keyboard, mouse, microphone, remote control device, button, joystick, trackball, touchpad, and lightpen. Some examples of output devices 1013 include a speaker and a printer. One specific type of output device that is typically included in a computer system 1000 is a display device 1015. Display devices 1015 used with embodiments disclosed herein may utilize any suitable image projection technology, such as liquid crystal display (LCD), light-emitting diode (LED), gas plasma, electroluminescence, or the like. A display controller 1017 may also be provided, for converting data 1007 stored in the memory 1003 into text, graphics, and/or moving images (as appropriate) shown on the display device 1015.

The various components of the computer system 1000 may be coupled together by one or more buses, which may include a power bus, a control signal bus, a status signal bus, a data bus, etc. For the sake of clarity, the various buses are illustrated in FIG. 10 as a bus system 1019.

### INDUSTRIAL APPLICABILITY

Following are sections in accordance with at least one embodiment of the present disclosure:
A1. A method for translation between source and target programming languages, the method comprising:
   based on a first program in a first programming language, generating a first program source internal representation that is expressed using a source language representation of a source programming language;
   based on the first program, generating a first program target internal representation that is expressed using a target language representation of a target programming language;
   interpreting the first program source internal representation with first program data to generate a first program source result;
   interpreting the first program target internal representation with the first program data to generate a first program target result;
   comparing the first program source result and the first program target result for consistency;
   when the first program source result and the first program target result are inconsistent, modifying at least one of the source language representation or the target language representation;
   when the first program source result and the first program target result are consistent, and based on a second program source program in the source programming language and the source language representation, generating a second program source internal representation of the second program source program;
   using the second program source internal representation, and based on the target language representation, generating a second program target internal representation of the second program source program; and
   using the second program target internal representation, generating a second program target program in the target programming language.
A2. The method of section A1, further comprising:
   training a generative artificial intelligence (AI) model on a source language corpus of the source programming language; and
   training the generative AI model on a target language corpus of the target programming language.
A3. The method of section A2, further comprising:
   generating, using the generative AI model, the source language representation for the source programming language; and
   generating, using the generative AI model, the target language representation for the target programming language.
A4. The method of any of sections A2 or A3, wherein the source language corpus includes at least one selected from source language grammar, source language syntax descriptions, and source language coding guides, and the target language corpus includes at least one selected from target language grammar, target language syntax descriptions, and target language coding guides.
A5. The method of any of sections A2-A4, further comprising training the generative AI model on a subject-matter corpus associated with at least one of geology, geophysics, petrophysics, geochemistry, drilling technology, oil and gas production technology, pipe, valve, and flow assurance technology, physics, or chemistry.
A6. The method of any of sections A1-A5, wherein the source language representation and the target language representation are respectively implemented in source and target deterministic context-free grammars.
A7. The method of any of sections A1-A6, further comprising:
   implementing, with second program test data, the second program source program to output a second program source result and the second program target program to output a second program target result;
   comparing the second program source result and the second program target result to determine a second consistency between the second program source result and the second program target result; and
   when the second program source result and the second program target result are inconsistent, modifying the second program target program.
A8. The method of section 7, further comprising performing a regression test to identify a consistency of the second program source result and a second program target result.
A9. The method of any of sections A1-A8, wherein the method is implemented on a server device in a cloud computing system.
A10. A computing system including a processor and memory, the memory including instructions that cause the processor to perform the method of any of sections A1-A9.
A11. A non-transient computer readable medium containing program instructions for causing a computer to perform the method of any of sections A1-A9.
B1. A method for translation between source and target programming languages, the method comprising:
   based on a first program in a first programming language, generating a first internal representation of the first program;
   based on the first internal representation, generating a second internal representation of the first program; and
   based on the second internal representation, generating a second program expressed in a second programming language.
B2. The method of section B1, further comprising:
   implementing the first internal representation using first data to generate first program results;
   implementing the second internal representation using the first data to generate second program results; and
   comparing the first program results and the second program results for consistency between the first program results and the second program results.
B3. The method of section B2, further comprising, when the first program results and the second program results are inconsistent, modifying the second internal representation.
B4. The method of any of sections B1-B3, further comprising:
   testing the first and second programs using program data to generate first and second program results, respectively; and
   comparing the first and second program results to determine a consistency between the first and second program results.
B5. The method of section B4, wherein comparing the first and second program results includes regression testing.
B6. The method of any of sections B1-B5, further comprising receiving, at a client device, a user input to generate the second program.
B7. The method of any of sections B1-B6, wherein the method is implemented on a server device in a cloud computing system.
B8. A computing system including a processor and memory, the memory including instructions that cause the processor to perform the method of any of sections B1-B6.
B9. A non-transient computer readable medium containing program instructions for causing a computer to perform the method of any of sections B1-B6.
C1. A method for training a generative artificial intelligence (AI) model to translate between source and target programming languages, the method comprising:
   training the generative AI model on a source language corpus of a source programming language and a target language corpus of a target programming language;
   generating a first program source internal representation of a first program;
   generating a first program target internal representation of the first program;
   using program data, applying an execution model to the first program source internal representation, the execution model outputting source internal results;
   using program data, applying the execution model to the first program target internal representation, the execution model outputting target internal results;
   comparing the source internal results and the target internal results for consistency between the source internal results and the target internal results; and
   when the source internal results and the target internal results are inconsistent, modifying the first program target internal representation.
C2. The method of section C1, further comprising, at a computing system that is implementing the generative AI model:
   generating a source language representation, the first program source internal representation expressed in the source language representation; and
   generating a target language representation, the first program target internal representation expressed in the target language representation.
C3. The method of section C2, wherein the source language corpus includes the source language representation and the target language corpus includes the target language representation.
C4. The method of any of sections C1-C3, further comprising applying a regression test to the source internal results and the target internal results to determine whether the source internal results and the target internal results are consistent.
C5. The method of any of sections C1-C4, wherein the execution model includes a compiler or an interpreter.
C6. The method of any of sections C1-C5, wherein the method is implemented on a server device in a cloud computing system.
C7. A computing system including a processor and memory, the memory including instructions that cause the processor to perform the method of any of sections C1-C5.
C8. A non-transient computer readable medium containing program instructions for causing a computer to perform the method of any of sections C1-C5.
D1. Any device, apparatus, system, kit, component, or subcomponent as illustrated or described, or method of manufacture or use thereof.
E1. A method having any or each permutation of features recited in the sections listed above.
F1. Any system, assembly, component, subcomponent, process, element, or portion thereof, as described or illustrated.
G1. A computer program comprising instructions for implementing a method of any one of sections A1-A9, B1-B7, C1-C6.
G2. A client-side computer program comprising instructions for executing at a client computing system:
   sending to a server device in a cloud computing system a program translation request that includes:
      a first computer program written in a first language, and
      a target language;
   receiving at the client computing system a translated computer program written in the target language, wherein the translated computer program implements the same functionality as the first computer program; and
   wherein the server device that receives the program translation request includes a server-side computer program for implementing the method of any one of sections A1-A8, B1-B5, and C1-C5, wherein the service device is disposed in a computing system.

One or more specific embodiments of the present disclosure are described herein. These described embodiments are examples of the presently disclosed techniques. Additionally, in an effort to provide a concise description of these embodiments, not all features of an actual embodiment may be described in the specification. It should be appreciated that in the development of any such actual implementation, as in any engineering or design project, numerous embodiment-specific decisions will be made to achieve the developers'specific goals, such as compliance with system-related and business-related constraints, which may vary from one embodiment to another. Moreover, it should be appreciated that such a development effort might be complex and time consuming, but would nevertheless be a routine undertaking of design, fabrication, and manufacture for those of ordinary skill having the benefit of this disclosure.

Additionally, it should be understood that references to “one embodiment” or “an embodiment” of the present disclosure are not intended to be interpreted as excluding the existence of additional embodiments that also incorporate the recited features. For example, any element described in relation to an embodiment herein may be combinable with any element of any other embodiment described herein. Numbers, percentages, ratios, or other values stated herein are intended to include that value, and also other values that are “about” or “approximately” the stated value, as would be appreciated by one of ordinary skill in the art encompassed by embodiments of the present disclosure. A stated value should therefore be interpreted broadly enough to encompass values that are at least close enough to the stated value to perform a desired function or achieve a desired result. The stated values include at least the variation to be expected in a suitable manufacturing or production process, and may include values that are within 5%, within 1%, within 0.1%, or within 0.01% of a stated value.

A person having ordinary skill in the art should realize in view of the present disclosure that equivalent constructions do not depart from the spirit and scope of the present disclosure, and that various changes, substitutions, and alterations may be made to embodiments disclosed herein without departing from the spirit and scope of the present disclosure. Equivalent constructions, including functional “means-plus-function” clauses are intended to cover the structures described herein as performing the recited function, including both structural equivalents that operate in the same manner, and equivalent structures that provide the same function. It is the express intention of the applicant not to invoke means-plus-function or other functional claiming for any claim except for those in which the words ‘means for’ appear together with an associated function. Each addition, deletion, and modification to the embodiments that falls within the meaning and scope of the claims is to be embraced by the claims.

The terms “approximately,” “about,” and “substantially” as used herein represent an amount close to the stated amount that is within standard manufacturing or process tolerances, or which still performs a desired function or achieves a desired result. For example, the terms “approximately,” “about,” and “substantially” may refer to an amount that is within less than 5% of, within less than 1% of, within less than 0.1% of, and within less than 0.01% of a stated amount. Further, it should be understood that any directions or reference frames in the preceding description are merely relative directions or movements. For example, any references to “up” and “down” or “above” or “below” are merely descriptive of the relative position or movement of the related elements.

The present disclosure may be embodied in other specific forms without departing from its spirit or characteristics. The described embodiments are to be considered as illustrative and not restrictive. The scope of the disclosure is, therefore, indicated by the appended claims rather than by the foregoing description. Changes that come within the meaning and range of equivalency of the claims are to be embraced within their scope.

What is claimed is:

1. A method for translation between source and target programming languages, the method comprising:
based on a first program in a first programming language, generating a first program source internal representation that is expressed using a source language representation of a source programming language;
based on the first program, generating a first program target internal representation that is expressed using a target language representation of a target programming language;
interpreting the first program source internal representation with first program data to generate a first program source result;
interpreting the first program target internal representation with the first program data to generate a first program target result;
comparing the first program source result and the first program target result for consistency;
when the first program source result and the first program target result are inconsistent, modifying at least one of the source language representation or the target language representation;
when the first program source result and the first program target result are consistent, and based on a second program source program in the source programming language and the source language representation, generating a second program source internal representation of the second program source program;
using the second program source internal representation, and based on the target language representation, generating a second program target internal representation of the second program source program; and
using the second program target internal representation, generating a second program target program in the target programming language.

2. The method of claim 1, further comprising:
training a generative artificial intelligence (AI) model on a source language corpus of the source programming language; and
training the generative AI model on a target language corpus of the target programming language.

3. The method of claim 2, further comprising:
generating, using the generative AI model, the source language representation for the source programming language; and
generating, using the generative AI model, the target language representation for the target programming language.

4. The method of claim 2, wherein the source language corpus includes at least one selected from source language grammar, source language syntax descriptions, and source language coding guides, and the target language corpus includes at least one selected from target language grammar, target language syntax descriptions, and target language coding guides.

5. The method of claim 2, further comprising training the generative AI model on a subject-matter corpus associated with at least one of geology, geophysics, petrophysics, geochemistry, drilling technology, oil and gas production technology, pipe, valve, and flow assurance technology, physics, or chemistry.

6. The method of claim 1, wherein the source language representation and the target language representation are respectively implemented in source and target deterministic context-free grammars.

7. The method of claim 1, further comprising:
implementing, with second program test data, the second program source program to output a second program source result and the second program target program to output a second program target result;
comparing the second program source result and the second program target result to determine a second consistency between the second program source result and the second program target result; and
when the second program source result and the second program target result are inconsistent, modifying the second program target program.

8. The method of claim 7, further comprising performing a regression test to identify a consistency of the second program source result and a second program target result.

9. The method of claim 1, wherein the method is implemented on a server device in a cloud computing system.

10. A method for translation between source and target programming languages, the method comprising:
based on a first program in a first programming language, generating a first internal representation of the first program;
based on the first internal representation, generating a second internal representation of the first program; and
based on the second internal representation, generating a second program expressed in a second programming language.

11. The method of claim 10, further comprising:
implementing the first internal representation using first data to generate first program results;
implementing the second internal representation using the first data to generate second program results; and
comparing the first program results and the second program results for consistency between the first program results and the second program results.

12. The method of claim 11, further comprising, when the first program results and the second program results are inconsistent, modifying the second internal representation.

13. The method of claim 10, further comprising:
testing the first and second programs using program data to generate first and second program results, respectively; and
comparing the first and second program results to determine a consistency between the first and second program results.

14. The method of claim 13, wherein comparing the first and second program results includes regression testing.

15. The method of claim 10, further comprising receiving, at a client device, a user input to generate the second program.

16. A method for training a generative artificial intelligence (AI) model to translate between source and target programming languages, the method comprising:
training the generative AI model on a source language corpus of a source programming language and a target language corpus of a target programming language;
generating a first program source internal representation of a first program;
generating a first program target internal representation of the first program;
using program data, applying an execution model to the first program source internal representation, the execution model outputting source internal results;
using program data, applying the execution model to the first program target internal representation, the execution model outputting target internal results;
comparing the source internal results and the target internal results for consistency between the source internal results and the target internal results; and
when the source internal results and the target internal results are inconsistent, modifying the first program target internal representation.

17. The method of claim 16, further comprising, at a computing system that is implementing the generative AI model:
generating a source language representation, the first program source internal representation expressed in the source language representation; and
generating a target language representation, the first program target internal representation expressed in the target language representation.

18. The method of claim 17, wherein the source language corpus includes the source language representation and the target language corpus includes the target language representation.

19. The method of claim 16, further comprising applying a regression test to the source internal results and the target internal results to determine whether the source internal results and the target internal results are consistent.

20. The method of claim 16, wherein the execution model includes a compiler or an interpreter.
